(19) United States
(12) Patent Application Publication
(10) Pub. No.: US 2013/0075204 A1
(43) Pub. Date: Mar. 28, 2013

(54) LOAD-INDEPENDENT MOTION CONTROL SYSTEM

(71) Applicants: Madhav S. Puppala, Glenview, IL (US); Ghaffar Kazkaz, Glenview, IL (US); Thomas W. Moeller, Glenview, IL (US); Bradley G. Carman, Glenview, IL (US); John R. Wolfe, Glenview, IL (US); Frank Otte, Glenview, IL (US)

(72) Inventors: Madhav S. Puppala, Glenview, IL (US); Ghaffar Kazkaz, Glenview, IL (US); Thomas W. Moeller, Glenview, IL (US); Bradley G. Carman, Glenview, IL (US); John R. Wolfe, Glenview, IL (US); Frank Otte, Glenview, IL (US)

(73) Assignee: ILLINOIS TOOL WORKS INC., Glenview, IL (US)

(21) Appl. No.: 13/702,722

(22) PCT Filed: Aug. 3, 2011
(86) PCT No.: PCT/US11/46441

§ 371 Date: Dec. 7, 2012

Related U.S. Application Data
(60) Provisional application No. 61/370,665, filed on Aug. 4, 2010.

(51) Int. Cl. F16D 59/00

(52) U.S. Cl. CPC F16D 59/00
USPC 188/67

(57) ABSTRACT

A motion control system configured to control motion of a load object independent of the load object, includes a main housing having an internal nut secured with respect to a longitudinal axis of the main housing, and a threaded helical gear movably secured within the main housing. The threaded helical gear includes an end configured to be operatively secured to the load object. The helical gear threadably engages the internal nut. One or both of a first frictional force between the helical gear and the nut or a second frictional force between the nut and at least a portion of the main housing provides a resistive force that controls motion of the load object.

### RELATED APPLICATIONS

This application relates to and claims priority benefits from U.S. Provisional Patent Application No. 61/370,665 entitled “Load-Independent Motion Control Device,” filed Aug. 4, 2011, which is hereby incorporated by reference in its entirety.

### FIELD OF EMBODIMENTS OF THE INVENTION

Embodiments of the present invention generally relate to a motion control system configured to control opening and closing speeds of components, such as compartment doors, handles, etc., independent of the load applied.

### BACKGROUND

Present devices used for controlling the motion of a component, such as a glove box compartment door within a vehicle, include air dampers, viscous fluid dampers and frictional dampers. With such devices, resistive force is typically not proportional to the mass of the object or the force being applied. Therefore, heavy objects within the glove compartment generate faster opening motion. Conversely, lighter objects within the glove compartment typically produce slower opening motion.

Additionally, in the case of air dampers, a certain travel distance is generally needed before the resistive force builds to a significant value. Consequently, an initial portion of the travel may be in free fall, generating jerking and undesirable impacts.

With fluid dampers, the viscosity of the fluid may change dramatically over a range of temperatures. As such, opening time may significantly vary between summer and winter, for example.

### SUMMARY OF EMBODIMENTS OF THE INVENTION

In contrast to typical dampening devices, embodiments of the present invention provide load-independent motion control systems that are configured to provide a smooth and consistent opening motion that generally remains the same regardless of the weight of objects of and within a component, such as a glove compartment, drawer, cabinet, or the like.

Certain embodiments of the present invention provide a motion control system configured to control motion of a load object (such as a glove compartment door) independent of the load object. The system may include a main housing having an internal nut secured with respect to a longitudinal axis of the main housing, wherein the main housing prevents the internal nut from longitudinal or lateral movement within the main housing. The system may also include a threaded helical gear movably secured within the main housing. The threaded helical gear includes an end configured to be operatively secured to the load object. The helical gear threadably engages the internal nut, wherein linear movement of the threaded helical gear within the main housing causes the internal nut to rotate about the longitudinal axis. A first frictional force between the helical gear and the nut and/or a second frictional force between the nut and at least a portion of the main housing provides a resistive force that controls motion of the load object.

The threaded helical gear may be prevented from rotating about the longitudinal axis. For example, the threaded helical gear may be positioned within a gear cylinder such that the gear cylinder allows the gear to only move in a linear direction, but not a rotational direction. In one embodiment, the helical gear may include a tab at an upper end that is slidably secured within a longitudinal groove formed within the gear cylinder.

The nut may be wedged between lower and upper internal surfaces of the main housing. Additionally or alternatively, outer surfaces of the nut may conform to internal lateral surfaces of the main housing. Also, the system may include one or more additional internal nuts that threadably engage the helical gear.

The main housing may be formed of Delrin/Acetal and ultra-high molecular weight polyethylene (UHMW). The internal nut may be formed of Delrin AF. The helical gear may be formed of Delrin/Acetral with silicone. Alternatively, the main body may be formed of just Delrin/Acetral or Polycarbonite/Acrylonitrile Butadiene Styrene (PC/ABS), while the nut is formed of Nylon 6/6. Additionally, the nut may be formed of Delrin/Acetral with silicone.

### BRIEF DESCRIPTION OF SEVERAL VIEWS OF THE DRAWINGS

FIG. 1 illustrates an isometric top view of a motion control system, according to an embodiment of the present invention.

FIG. 2 illustrates a front view of a motion control system, according to an embodiment of the present invention.

FIG. 3 illustrates a longitudinal cross-sectional view of a motion control system through line 3-3 of FIG. 1, according to an embodiment of the present invention.

FIG. 4 illustrates a longitudinal cross-sectional view of an internal chamber of a motion control system, according to an embodiment of the present invention.

FIG. 5 illustrates an isometric view of a motion control system operatively connected to a glove compartment door of a vehicle, according to an embodiment of the present invention.

FIG. 6 illustrates a longitudinal cross-sectional view of a motion control system, according to an embodiment of the present invention.

FIG. 7 illustrates a longitudinal cross-sectional view of a motion control system, according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE INVENTION

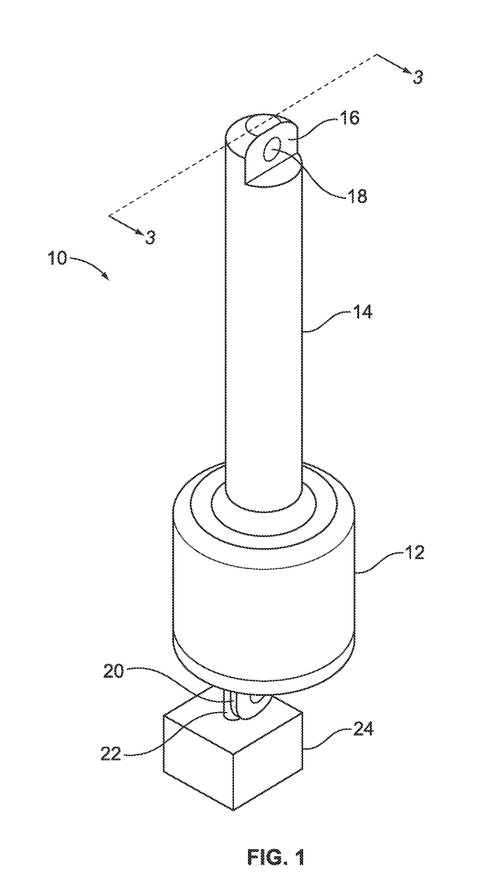

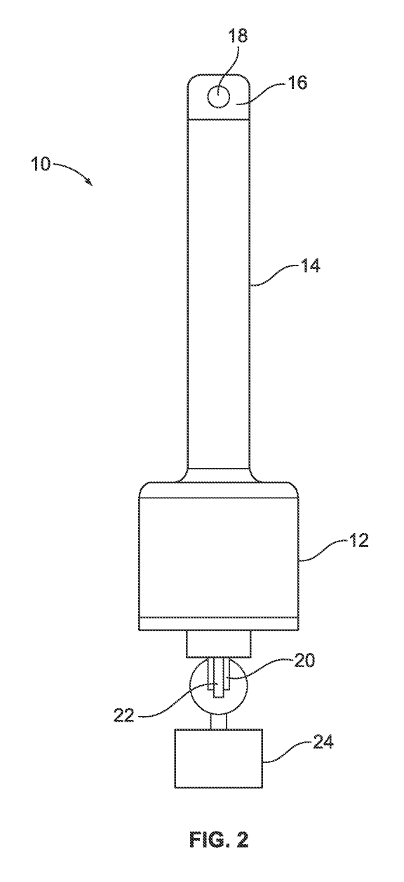

FIGS. 1 and 2 illustrate isometric top and front views, respectively, of a motion control system 10, according to an embodiment of the present invention. The system 10 includes a main housing 12 integrally connected to a gear cylinder 14. A terminal end of the cylinder 14 includes a fastening joint 16 that is configured to be securely fastened to a structure (not shown), such as an internal frame of a vehicle. For example, the joint 16 may include a through-hole 18 configured to receive and rotatably retain a fastener, such as a bolt.

The main housing 12 and cylinder 14 define an internal chamber (not shown in FIGS. 1 and 2) that slidably retain a helical gear 20. A distal end 22 of the gear 20 passes through the distal end of the main housing 12 and connects to a load object 24, such as a glove compartment door.

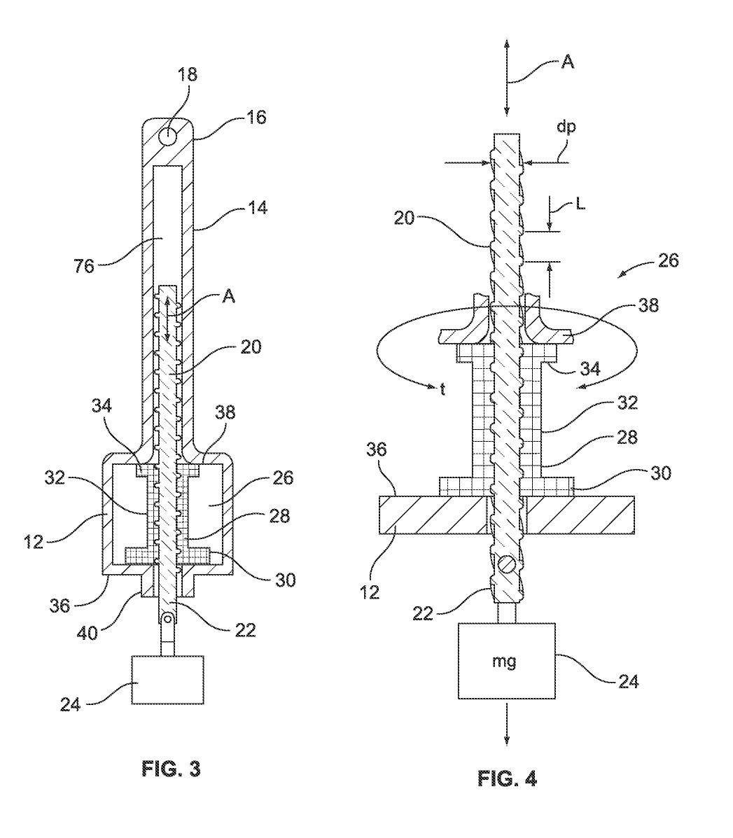

FIG. 3 illustrates a longitudinal cross-sectional view of the motion control system 10 through line 3-3 of FIG. 1, according to an embodiment of the present invention. As shown, the helical gear 20 is movably secured within the internal chamber 26 defined within the main housing 12 and the cylinder 14. The gear cylinder 14 is sized so that the helical gear 20 may stably and consistently move in the directions of arrow A, such as a piston. The cylinder 14 prevents the helical gear 20 from rotating or spinning about its central axis. For example, the helical gear 20 may include a tab at an upper end that is slidably secured within a longitudinal groove (not shown) formed within an internal wall of the gear cylinder 14.

An internal nut 28 is positioned within the internal chamber 26. The nut 28 includes a base 30 integrally connected to a shaft 32, which, in turn, integrally connects to an upper flange 34. The base 30 rests upon a lower internal surface or pad 36 of the main housing 12, while the upper flange 34 abuts into an upper internal surface 38 of the main housing 12.

A gear channel is formed through the nut 28 and is aligned to receive the helical gear 20. As shown, the gear 20 passes through the nut 28 and out of the main housing 12 through a lower collar 40.

FIG. 4 illustrates a longitudinal cross-sectional view of the internal chamber 26 of the motion control system 10. For the sake of clarity, portions of the main body 12 are not shown.

In operation, as the helical gear 20 moves within the internal chamber 26 in the direction of arrows A, the gear 20 also moves through the nut 28. As the gear 20 moves through the nut 28, the nut 28 rotates or spins about its central axis in the directions of t. The nut 28 is prevented from moving up or down in the directions of arrow A due to the fact that the nut 28 is wedged between the lower and upper internal surfaces 36 and 38 of the internal chamber 26 of the main body 12, as shown in FIG. 3.

Referring to FIGS. 3 and 4, the load object 24 has a mass m, which is connected to the end 22 of the helical gear 20. The driving force of the mass is given as P=mg, where g is the gravitational acceleration of the load object 24.

The helical gear 20 has a pitch diameter dₚ, and a thread lead L between threads. As noted, the nut 28 is threadably mated to the gear 20, which is able to move up or down in the directions of arrow A, but secured against spinning about its central axis. As the gear 20 moves down due to the force P, the nut 28 spins in the direction of t, but is prevented from moving in the directions of arrow A. As such, resistive force is generated by the friction between the nut 28 and the lower internal surface 36 of the main housing 12. The resulting net torque τ driving the nut 28 is given by the following equation:

$$τ = \frac{{mgd}_{p}}{2} \times \frac{L \times cos α - μ π {d}_{p}}{π {d}_{p} \times cos α + μ L} - \frac{mg}{2} {μ}_{c} {d}_{c} \qquad ( 1 )$$

where μ_{c} is the coefficient of friction between the base 30 of the nut 28 and the lower internal surface 36 of the main housing 12, μ is the friction between the nut 28 and the helical gear 20, d_{c} is the average diameter of the friction surface between the base 30 of the nut 28 and the lower surface 36 of the main housing 12, dₚ is the pitch diameter of the gear 20, L is the lead of the gear 20, and α is the pressure angle of the gear thread.

The net torque τ can be controlled through geometric considerations (L, dₚ, d_{c}, and α) and frictional coefficients, μ and μ_{c}.

As but one example, assume a system with a small μ (friction between nut 28 and gear 20). In this simple example, the friction coefficient μ between the nut 28 and the gear 20 can be made small enough so that the terms μπdₚ and μL can be ignored, and equation (1) becomes the following:

$$τ = \frac{mg}{2} ( \frac{L}{π} - {μ}_{c} {d}_{c} )$$

The net tangential force Fₜ driving the nut 28 applied at the pitch radius is then given by the following:

$${F}_{t} = \frac{2 τ}{{d}_{p}} = \frac{mg}{{d}_{p}} ( \frac{L}{π} - {μ}_{c} {d}_{c} )$$

The tangential acceleration of the nut 28 at the pitch radius is then given by the following:

$${a}_{t} = \frac{{F}_{t}}{m} = \frac{g}{{d}_{p}} ( \frac{L}{π} - {μ}_{c} {d}_{c} )$$

Therefore, the axial acceleration of the load object 24 moving down with the helical gear 28 is given by:

$$a = {a}_{t} \times \frac{L}{π {d}_{p}} = \frac{L}{{π }^{2} {d}_{p}^{2}} ( L - {πμ}_{c} {d}_{c} ) \qquad ( 2 )$$

The time to travel distance S in the axial direction is given by:

$$t = \sqrt{\frac{2 S}{a}} = π {d}_{p} \sqrt{\frac{2 S}{gL ( L - {πμ}_{c} {d}_{c} )}} \qquad ( 3 )$$

Equations (2) and (3) show that the acceleration and the time to travel a certain distance by the load object 24 in the gear axial direction are independent of the mass m of the load object 24, and therefore independent of the load object 24 itself.

Additionally, equations (2) and (3) demonstrate that desired values of a and t can be controlled by proper selection of the values of L, dₚ, d_{c}, and μ_{c}. Overall, the system 10 provides a system for motion control that is independent of the load object 24.

The value of L(L−πμ_{c}d_{c})/π²dₚ² is reduced to provide an efficient motion control system 10. Thus, the quantity L−πμ_{c}d_{c} is minimized and kept positive. For example, in order to safely and efficiently control opening motion, it has been found that the main housing 12 may be formed of Delrin/Acetal and UHMW, the helical gear 20 may be formed of Delrin/Acetal with silicone (for lubrication), and the nut 28 may be formed of Delrin AF. It has also been found that the main housing 12 being formed of Delrin/Acetal, and both the helical gear 20 and the nut 28 being formed of Delrin/Acetal with silicone (for lubrication) also provides a system that safely and efficiently controls opening motion. It has also been found that the main housing 12 being formed of Delrin/Acetal, the helical gear 20 being formed of Delrin/Acetal with silicone (for lubrication) and the nut 28 being formed of Nylon 6/6 provides a system that safely and efficiently controls opening motion. Further, it has been found that the main housing 12 being formed of PC/ABS, the helical gear 20 being formed of Delrin/Acetal with silicone (for lubrication) and the nut 28 being formed of Nylon 6/6 also provides a system that safely and efficiently controls opening motion.

As yet another example, assume a system with little or no friction between the base 30 of the nut 28 and the lower internal surface 36 of the main body 12. In this case, μ_{c}d_{c} is eliminated from equation (1), which then becomes the following:

$$τ = \frac{{mgd}_{p}}{2} \times \frac{L \times cos α - μ π {d}_{p}}{π {d}_{p} \times cos α + μ L}$$

In this example, the motion is slowed through controlling the friction coefficient μ and the motion is independent of the load mass m. Therefore, the axial acceleration along the helical gear 28 is given by:

$$a = \frac{gL}{π {d}_{p}} \times \frac{L \times cos α - μ π {d}_{p}}{π {d}_{p} \times cos α + μ L}$$

Further, the time to travel distance S along the gear axial direction is given by the following:

$$t = \sqrt{\frac{2 S π {d}_{p} ( π {d}_{p} \times cos α + μ L )}{gL ( L \times cos α - πμ {d}_{p} )}}$$

In this case, obtaining a desirable value for the acceleration and the time to travel a certain distance may be achieved by selecting appropriate values of L, dₚ, α, and μ. For slow and gentle motion, the quantity L×cos α−πμdₚ is minimized and kept positive.

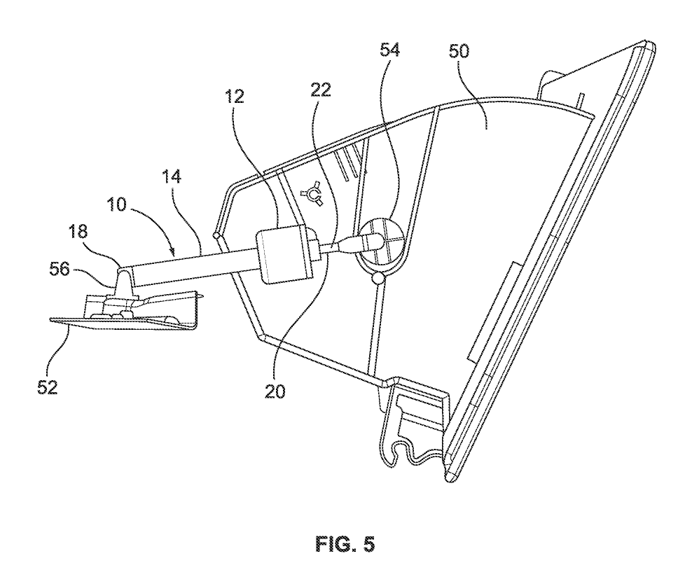

FIG. 5 illustrates an isometric view of the motion control system 10 operatively connected to a glove compartment door 50 of a vehicle, according to an embodiment of the present invention. The terminal end 16 of the gear cylinder 14 is pivotally connected to a frame 52, such as within the vehicle. The distal end 22 of the helical gear 20 is operatively linked to a portion of the glove compartment door 50.

Referring to FIGS. 3-5, in the case of the glove compartment, in some cases, the input force (load) is applied indirectly using a linkage 54. The system 10 is oriented so that the linkage force is along its axis, which is the same as the helical gear axis. Therefore, the equations for the acceleration a and the travel time t respectively become the following:

$$a = \frac{{R}_{m}}{{R}_{l}} \frac{g}{{π }^{2} {d}_{p}^{2}} ( L - {πμ}_{c} {d}_{c} )$$

$$t = π {d}_{p} \sqrt{\frac{{R}_{l}}{{R}_{m}}} \sqrt{\frac{2 S}{gL ( L - {πμ}_{c} {d}_{c} )}}$$

where Rₘ is the arm of the glove compartment center of mass relative to a hinge 56 and Rₜ is the linkage arm, which is the distance from the linkage point 54 to the hinge 56.

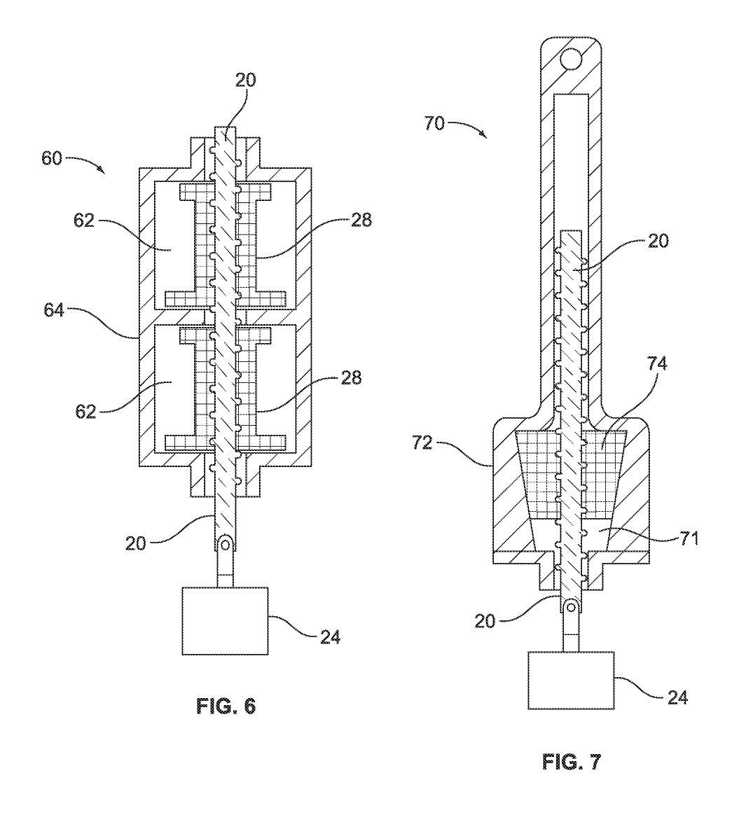

FIG. 6 illustrates a longitudinal cross-sectional view of a motion control system 60, according to an embodiment of the present invention. The system 60 includes two vertically-aligned nuts 28 within separate internal chambers 62 of a main body 64. The additional nut 28 provides additional resistive force. Thus, the system 60 may be used in to provide slower movement of the load object 24.

FIG. 7 illustrates a longitudinal cross-sectional view of a motion control system 70, according to an embodiment of the present invention. The system 70 is similar to the system 10 described above except that the internal chamber 71 of the main body 72 tapers down from top to bottom to accommodate a conforming nut 74. That is, the walls defining the internal chamber 71 conform to the contours of the nut 74. Further, as shown, the nut 74 frictionally engages the side internal walls of the main body 72, instead of a lower internal wall. In this manner, a larger frictional interface between the nut 74 and the main body 72 may be achieved. Indeed, the nut 74 may be sized to frictionally engage all of the internal walls of the main body. The opening speed will generally be slower with increased frictional surface area between the nut 74 and the main body 72. In any event, the nut 74 may be rotatably secured in position without the need for being wedged or compressed between a lower internal surface and an upper internal surface of the main body 72.

Thus, embodiments of the present invention provide load-independent motion control systems. The acceleration, velocity and time of travel over a given opening distance is independent of the mass of the object. A resistive force caused by the friction between the spinning nut(s) and (1) internal surface(s) of the main body, and/or (2) the helical gear slows down the opening motion. The resistive force is proportional to the mass and the driving force. As a result, the net force driving the load object is small compared to the weight of the object (mg) and proportional to the mass m. Therefore, the acceleration is independent of the mass and very small in comparison to the gravitational acceleration g.

Embodiments of the present invention may be used in any application where motion control is desired. For example, embodiments of the present invention may be used with respect to automobile glove compartments, cabinets, drawers, and the like.

While various spatial and directional terms, such as top, bottom, lower, mid, lateral, horizontal, vertical, front and the like may used to describe embodiments of the present invention, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A motion control system configured to control motion of a load object independent of the load object, said system comprising:
a main housing having an internal nut secured with respect to a longitudinal axis of said main housing, wherein said main housing prevents said internal nut from longitudinal or lateral movement within said main housing; and
a threaded helical gear movably secured within said main housing, wherein said threaded helical gear includes an end configured to be operatively secured to the load object, wherein said helical gear threadably engages said internal nut, wherein linear movement of said threaded helical gear within said main housing causes said internal nut to rotate about the longitudinal axis, and wherein one or both of a first frictional force between said helical gear and said nut or a second frictional force between said nut and at least a portion of said main housing provides a resistive force that controls motion of the load object.

2. The system of claim 1, wherein said threaded helical gear is prevented from rotating about the longitudinal axis.

3. The system of claim 1, further comprising a gear cylinder integrally connected to said main housing, wherein at least a portion of said threaded helical gear is positioned within said gear cylinder.

4. The system of claim 3, wherein said gear cylinder comprises a fastening joint configured to secure to a fixed frame.

5. The system of claim 1, wherein said load object is a glove compartment door.

6. The system of claim 1, wherein said nut is wedged between lower and upper internal surfaces of said main housing.

7. The system of claim 1, wherein outer surfaces of said nut conform to internal lateral surfaces of said main housing.

8. The system of claim 1, further comprising an additional internal nut that threadably engages said helical gear.

9. The system of claim 1, wherein said main housing is formed of Delrin/Acetal and UHMW, Delrin/Acetal, or PC/ABS, wherein said internal nut is formed of Delrin AF, Delrin/Acetal with silicone, or Nylon 6/6, and wherein said helical gear is formed of Delrin/Acetal with silicone.

10. A motion control system configured to control motion of a glove compartment door independent of the weight of the glove compartment door, said system comprising:
a main housing having an internal nut secured with respect to a longitudinal axis of said main housing, and wherein said main housing prevents said internal nut from longitudinal or lateral movement within said main housing;
a gear cylinder integrally connected to said main housing, wherein said gear cylinder includes a fastening joint configured to pivotally secure to a fixed frame connected to said glove compartment door; and
a threaded helical gear is movably secured within said main housing, wherein at least a portion of said threaded helical gear is positioned within said gear cylinder, wherein said threaded helical gear includes an end configured to be operatively linked to the glove compartment door, wherein said helical gear threadably engages said internal nut, wherein said threaded helical gear is prevented from rotating about the longitudinal axis, wherein linear movement of said threaded helical gear within said main housing causes said internal nut to rotate about the longitudinal axis, and wherein one or both of a first frictional force between said helical gear and said nut or a second frictional force between said nut and at least a portion of said main housing provides a resistive force that controls motion of the glove compartment door.

11. The system of claim 10, wherein said nut is wedged between lower and upper internal surfaces of said main housing.

12. The system of claim 10, wherein outer surfaces of said nut conform to internal lateral surfaces of said main housing.

13. The system of claim 10, further comprising an additional internal nut that threadably engages said helical gear.

14. The system of claim 10, wherein said main housing is formed of Delrin/Acetal and UHMW, Delrin/Acetal, or PC/ABS, wherein said internal nut is formed of Delrin AF, Delrin/Acetal with silicone, or Nylon 6/6, and wherein said helical gear is formed of Delrin/Acetal with silicone.

15. A motion control system configured to control motion of a load object independent of the load object, said system comprising:
a main housing having an internal nut secured with respect to a longitudinal axis of said main housing; and
a threaded helical gear movably secured within said main housing, wherein said threaded helical gear includes an end configured to be operatively secured to the load object, wherein said helical gear threadably engages said internal nut, wherein one or both of a first frictional force between said helical gear and said nut or a second frictional force between said nut and at least a portion of said main housing provides a resistive force that controls motion of the load object.

16. The system of claim 15, further comprising a gear cylinder integrally connected to said main housing, wherein at least a portion of said threaded helical gear is positioned within said gear cylinder.

17. The system of claim 15, wherein said nut is wedged between lower and upper internal surfaces of said main housing.

18. The system of claim 15, wherein outer surfaces of said nut conform to internal lateral surfaces of said main housing.

19. The system of claim 15, further comprising an additional internal nut that threadably engages said helical gear.

20. The system of claim 1, wherein said main housing is formed of Delrin/Acetal and UHMW, Delrin/Acetal, or PC/ABS, wherein said internal nut is formed of Delrin AF, Delrin/Acetal with silicone, or Nylon 6/6, and wherein said helical gear is formed of Delrin/Acetal with silicone.
